(19) United States
(12) Patent Application Publication
(10) Pub. No.: US 2025/0122760 A1
(43) Pub. Date: Apr. 17, 2025

(54) WINDOW, DOOR OR WALL FRAME ASSEMBLY WITH THERMALLY INSULATING TRUSS

(71) Applicant: Visionar Window Systems Inc., Langley (CA)

(72) Inventor: Johan SAWATZKY, Langley (CA)

(21) Appl. No.: 18/916,561

(22) Filed: Oct. 15, 2024

Related U.S. Application Data
(60) Provisional application No. 63/544,359, filed on Oct. 16, 2023.

(51) Int. Cl. E06B 3/26; E04B 2/96; E06B 3/263

(52) U.S. Cl. CPC E06B 3/26; E04B 2/967; E06B 3/2632; E06B 2003/26321; E06B 2003/2635; E06B 2003/26387

(57) ABSTRACT

A frame assembly for a window, door or wall comprise trusses that serve as a structural support and a thermal break. The frame assembly includes an inner frame portion and an outer frame portion, with the trusses mounted there-between. The trusses comprise thermally insulating strut members that have a lower thermal conductivity than the inner and outer frame portions, and in some embodiments between can be composed of carbon fiber. The thermally insulating strut members enables the trusses to serve as thermal breaks and provide heat insulation between the inner frame portion and the outer frame portion, while providing structural support to the frame assembly.

### CROSS-REFERENCE TO RELATED APPLICATION

The present application claims priority to U.S. provisional patent application No. 63/544,359, filed on Oct. 16, 2023, and entitled “Window, Door or Wall Frame Assembly with Thermally Insulating Truss”, the entirety of which is hereby incorporated by reference herein.

### FIELD

The present disclosure relates to framing and in particular to a frame assembly for a window, door, or wall having a thermally insulating truss.

### BACKGROUND

Because of its low weight, flexibility, and strength, aluminium is an ideal material for the construction of door and window frames. On the other hand, because of its relatively high heat conductivity of about 237 W/(k·M), aluminium is also poor for insulating buildings from heat loss.

In order to solve this problem, it is known to split an aluminium frame into multiple different pieces that are spaced apart by air gaps or “thermal breaks”. Air is a good insulator of heat and therefore the thermal breaks improve the overall heat-insulating properties of the frame. However, by splitting apart the frame in this fashion, the structural properties of the frame may be compromised.

Therefore, one object of the invention is to provide an improvement over prior art frame assemblies with thermal breaks but compromised structural properties, and in particular to provide a frame assembly with a structure that provides both mechanical support and a thermal break.

### SUMMARY

According to a first aspect of the disclosure, there is provided a frame assembly for a window, door, or wall. The frame assembly comprises an inner frame portion, an outer frame portion spaced from the inner frame portion, and at least one truss positioned between the inner and outer frame portions. Each truss comprises a first beam and a second beam spaced from the first beam, and multiple strut members interconnecting the first and second beams at nodes spaced along the length of the beams. Each strut member has a first end connected to a node of the first beam and a second end connected to a node of the second beam. The strut members are composed of a thermally insulating material having a lower thermal conductivity than the inner and outer frame portions. The inner frame portion and the outer frame portion define a longitudinal direction extending peripherally around the window, door or wall, and the truss provides a structural support to and a thermal break between the inner and outer frame portions.

The thermally insulating material of the strut members can have a thermal conductivity between 0.04 W/(m·k) and 24 W/(m·K), and can be for example, be carbon fiber. Alternatively, the thermally insulating material of the strut members can be selected from a group consisting of: wood, fiberglass, polyamide, and titanium. At least one of the first and second beams can be composed of aluminum. Alternatively, the beams can be composed of a thermally insulating material having a lower thermal conductivity than the inner and outer frame portions, such as carbon fiber.

The multiple strut members can be connected to each of first and second beams at alternating acute and obtuse angles to define a “W” configuration.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIGS. 1A and 1B are perspective views of a window frame assembly having a thermally insulating truss according to an embodiment of the disclosure, wherein FIG. 1A shows the window frame assembly with glazing and FIG. 1B shows the window frame assembly without glazing;

FIG. 2 is a side view of the window frame assembly of FIG. 1, showing the thermally insulating truss in between inner and outer frame portions, according to an embodiment of the disclosure;

FIGS. 3A and 3B are sectioned side and perspective views of one truss and corresponding inner and outer frame portions, according to an embodiment of the disclosure;

FIGS. 4A and 4B are side and top sectioned views showing edge and central frame portions of the window frame assembly of FIG. 1 mounted to a wall, according to an embodiment of the disclosure;

FIGS. 5A and 5B are side and top sectioned views showing edge and central frame portions of the window-wall frame assembly mounted to a wall, according to another embodiment of the disclosure; and

FIGS. 6A and 6B are side and top sectioned views showing edge and central frame portions of the wall frame assembly mounted to a wall, according to another embodiment of the disclosure.

### DESCRIPTION

The present disclosure seeks to provide improved frames for windows, doors and walls. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a frame assembly for a window, door or wall, and having one or more trusses that serves as a structural support and a thermal break. The frame assembly includes an inner frame portion and an outer frame portion, with the trusses mounted in between the inner and outer frame portions. The inner frame portion may be a portion of the frame assembly that faces the interior of a building or structure once the window, door or wall is installed therein. Conversely, the outer frame portion may be a portion of the frame assembly that faces the exterior of a building or structure once the window, door or wall is installed therein. The trusses comprise thermally insulating strut members that have a thermal conductivity below the inner and outer frame portions. In some embodiments, the thermally insulating strut members have a thermal conductivity below the thermal conductivity of aluminum and in some other embodiments between 0.04 W/(m·k) and 24 W/(m·K). The thermally insulating strut members enable the trusses to serve as thermal breaks and provide heat insulation between the inner frame portion and the outer frame portion.

Each truss comprises a pair of beams that are interconnected by the thermally insulating strut members in a configuration that enables the truss to provide structural support to the frame assembly. In some embodiments the pair of beams are arranged in a parallel spaced configuration, and each strut member is connected at each end to nodes at the respective beams. In some embodiments the nodes are spaced along each of the two beams in different, staggered locations, and the strut members connect diagonally to the two beams at alternating acute and obtuse angles to form a “W” configuration; in alternative embodiments the nodes have different spacing along the beams and the interconnecting members are connected to the beams in different configurations. In some embodiments the beams are composed of aluminum and the strut members are composed of carbon fibre. In other embodiments the beams and interconnecting members can be composed of different materials; for example, the strut members can be composed of one or more of: fibreglass, polyamide, titanium, or wood.

Together, the inner frame portion and the outer frame portion define a longitudinal direction extending peripherally around the window, door or wall, and the trusses extend longitudinally in between the inner frame and outer frame portions.

The inner frame portion and the outer frame portion may comprise features for mating with or otherwise engaging corresponding features in the trusses. For example, at least one of the inner frame portion and the outer frame portion may comprise hooks for mating with or otherwise engaging corresponding grooves in the beams of the trusses, or the beams may comprise hooks for mating with or otherwise engaging corresponding grooves in at least one of the inner frame portion and the outer frame portion. Advantageously, the trusses provide the primary structural support for the frame assembly, and portions of the inner or outer frame portions can therefore be decorative structures that provide little to no structural support; for example, the inner frame portion can comprise decorative cladding or panelling of various materials.

Advantageously over prior art window frame designs, the truss provides both structural and thermal insulating properties to the window frame assembly. In the prior art, a number of different materials have been used to create a thermal break between the exterior and interior of a window; however none were sufficient to also serve as a primary structural member. For example, carbon fiber has been previously attempted as a material in window frames, but was abandoned because carbon fiber is difficult to fabricate and is susceptible to structural failure from physical impact during install and during its life span. On impact carbon fiber can develop cracking which is hard to identify and can cause structural failure.

One embodiment of this disclosure uses carbon fiber struts and presents a clever solution to this prior art problem. The carbon fiber struts are located inside the aluminum beams of the truss and are therefore protected from impact damage. The truss also has multiple individual struts which introduce redundancy where if one strut fails the window structure has many other struts to maintain its overall structural integrity. Also the aluminum beams are fabricated around the carbon fiber resulting in minimal fabrication needed to the carbon fiber itself.

Turning now to the drawings, embodiments of the disclosure will be described in detail.

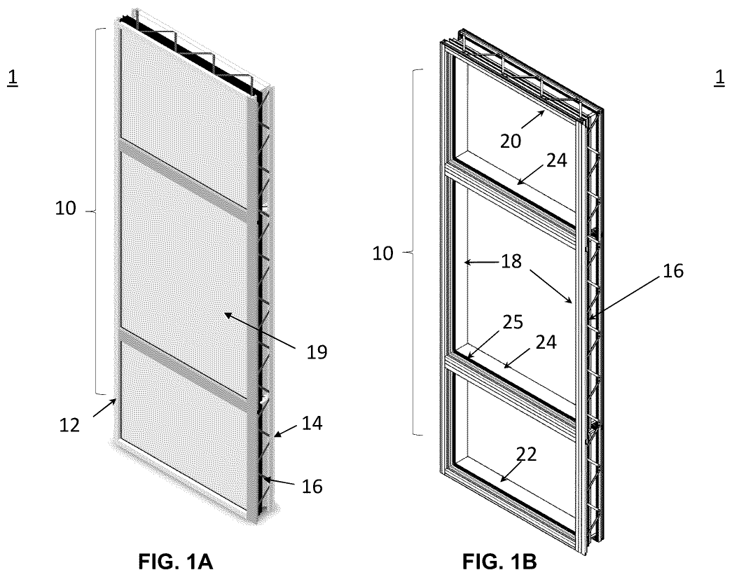

Referring first to FIGS. 1A and 1B and according to a first embodiment, there is shown a perspective view of a window system 1. The window system 1 includes a frame assembly 10 generally comprising an outer frame portion 12, an inner frame portion 14, and a truss 16 in between the inner and outer frame portions 12, 14. In this embodiment, the inner and outer frame portions 12, 14 define a pair of vertical jambs (left and right side jambs 18) a pair of horizontal jambs (head jamb 20, sill jamb 22), and a pair of horizontal mullions 24 that are interconnected to form a window frame. The vertical and horizontal jambs and the mullions are provided with a channel 25 to secure a sealed glazing unit 19 that can comprise multiple spaced glazing sheets. In this embodiment, the sealed glazing unit 19 is provided with three layers of glazing; however, a sealed glazing unit 19 with a different number of glazing layers can be provided in alternative embodiments (not shown). In this embodiment, the window frame is configured with two mullions 24 but can alternatively feature more or fewer mullions to accommodate different designs.

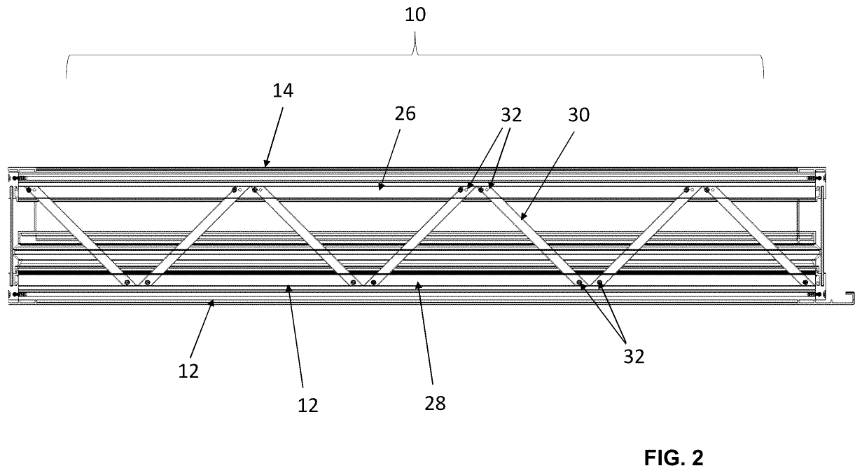

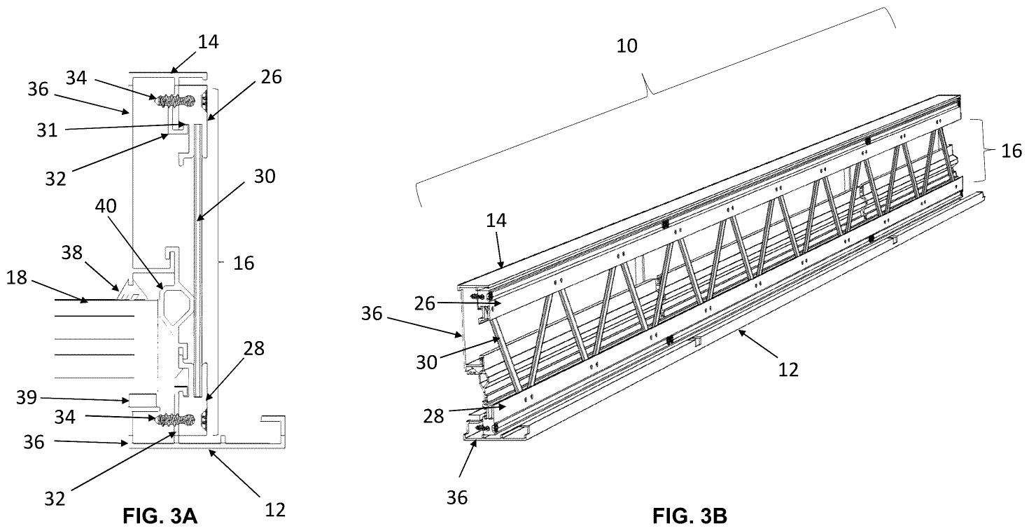

FIGS. 2, 3A and 3B show the internal structure of one side of the frame assembly 10 in greater detail. Frame assembly 10 includes an inner frame portion 14 facing an interior of the structure or building into which window 1 is set. Frame assembly 10 further includes an outer frame portion 12 facing an exterior of the structure or building into which window 1 is set.

Between inner frame portion 14 and outer frame portion 12 is provided the truss 16, which provides structural support to and a thermal break between the outer and inner frame portions 12, 14. The truss 16 comprises a longitudinally extending interior beam 26 physically coupled to the inner frame portion 14, a longitudinally extending exterior beam 28 parallel to the interior beam 26 and physically coupled to the outer frame portion 12, and multiple struts 30 interconnecting the inner and exterior beams 26, 28. Each strut 30 has a first end coupled to a connecting node 32 in the inner beam and a second end coupled to a node 32 in the outer beam 28. The connecting nodes 32 can be bolts that extend through bore holes in the beams 26, 28 through each end of each strut 30, or any other suitable type of connector for connecting truss members together, such as welds or screws. In some embodiments, the beams 26, 28 are composed of aluminum and the struts are composed of carbon fiber, which has a relatively low thermal conductivity in the order of 10.5 W/(m·K) or lower and thus serves as an effective thermal insulator. In one specific embodiment, the struts are approximately 18 mm long and are composed of a T300 standard modulus carbon fiber composite pultrusion with dimensions of 12 mm×3 mm.

In other embodiments, the strut can be composed of a different thermally insulting material that also has a relatively low thermal conductivity; for example, the strut can be composed of wood, titanium, polyamide, or fiberglass, which have thermal conductivities that range from 0.04 W/(m·k) and 24 W/(m·K). Because the truss is providing structural support as well as thermal isolation, certain materials for the struts can be selected based on their performance in different environments.

As can be most clearly seen in FIGS. 3A and 3B, the inner frame portion 14 comprises cladding 36 that extends longitudinally around the window frame to provide an aesthetic covering to the interior of the window frame. The cladding 36 includes a longitudinally extending clip 32 for connecting to the inner beam 26 and a longitudinally extending gasket 38 for providing a seal between the glazing units 19 and the inner frame portion 14. The outer frame portion 12 also comprises longitudinally extending cladding 36 that includes a longitudinally extending clip 32 for connecting the outer beam 28 to the outer frame portion 12, and a longitudinally extending gasket 39 for providing a seal between the glazing unit 19 and the outer frame portion 12. The cladding can be composed of various aesthetically appealing materials and patterns, such as wood, stainless steel, copper, gold or plastic.

Each of the inner and outer beams 26, 28 are provided with connectors that respectively connect the truss 16 to the outer and inner frame portions 12, 14. These connectors include longitudinally extending channels 31 that receives the clips 32 of the inner or outer frame portions 14, 12, which are held by pressure against the glazing unit 19 and gaskets 38, 39, and can be readily removed in case the glazing unit 19 needs to be serviced, e.g. to replace broken glass.

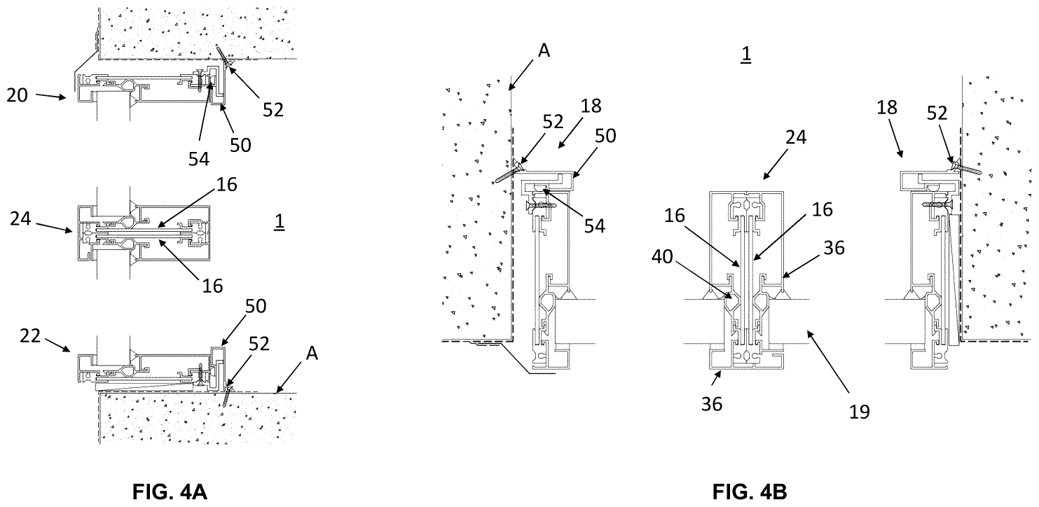

Screws 34 are provided to connect two trusses 16 together at a vertical joint such as shown in FIG. 4B.

The frame assembly 100 also includes a longitudinally extending polyamide glass chair 40 that connects to the cladding 36 of inner frame portion 14 and outer frame portion 12 and serves to seat the window glazing 19 in the frame, hold cladding 34 in place, and create a continuous water barrier to stop water from penetrating to the interior of a building. The polyamide glass material has a low thermal conductivity and thus also serves as a thermal break in between the inner and outer frame portions 12, 14.

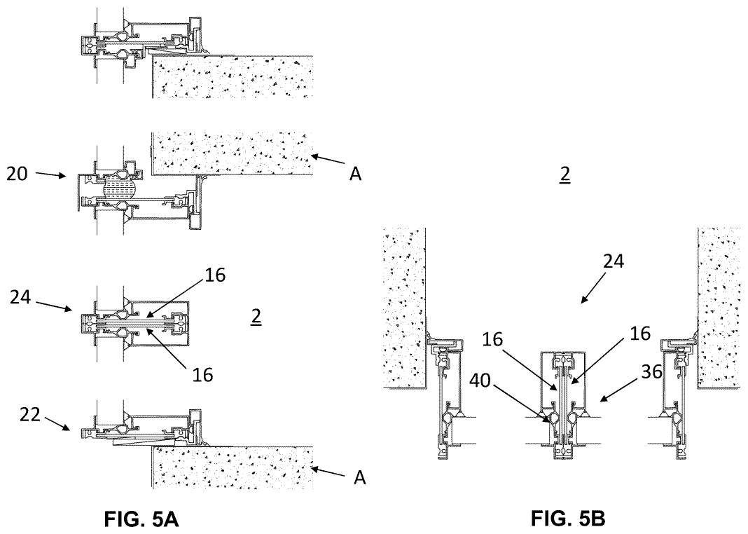

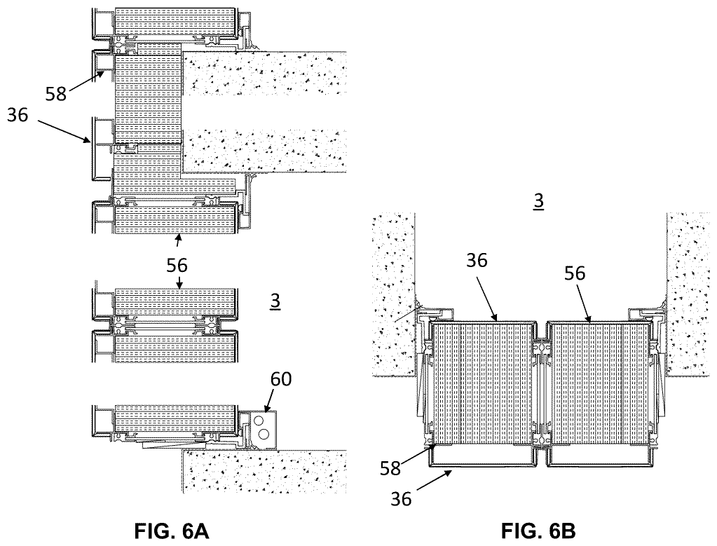

Referring now to FIGS. 4A/B to 6A/B, the frame assembly 10 can be installed 10 in a window system 1 (FIGS. 4A and 4B), window-wall system 2 (FIGS. 5A and 5B), and a wall system 3 (FIGS. 6A and 6B). The frame assembly 10 can also be readily installed in a door system (not shown), as would be apparent to one skilled in the art. The different frame portions (i.e., outer frame portion 12, truss 16, and inner frame portion 14) of the different jambs 18, 20, 22, 24 that make up the frame assembly 10 define respective longitudinal directions that extend peripherally around the window, wall, or door frame. Therefore, the insulating and structural assemblies (comprising heat-insulating portions and structural portions, as described above) in the jambs also extend in the longitudinal direction and around the periphery of the door frame.

As can be seen in FIGS. 4A and 4B, the window system 1 comprises multiple glazing units 19, and the frame assembly 10 includes jambs 18, 20, 22 and vertical and horizontal mullions 24 with double trusses 16 to contain glazing units 18 on both sides. Each truss 16 and a corresponding polyamide glass chair 40 is configured to secure a respective sealed glazing unit 19. The insulated glazing unit 19 in this illustrated embodiment that is 1¾″ thick and can contain a different number of glass panes depending on the glass manufacturer. The interior frame portion 14 comprises cladding 36 that is connected to and covers both trusses 16. Similarly, the exterior frame portion 12 comprises cladding 36 that covers both trusses 16. The perimeter mullions (i.e. jambs 18, 20, 22) are mounted to a frame anchor bracket 50, which in turn are mounted to a substrate A in a wall opening by anchor screws 52. Gaskets 54 are installed around the perimeter of the frame assembly 10 and each bracket 50 to provide a seal. The frame anchor bracket 50 allow the frame assembly 10 to slide up and down to accommodate expansion and contraction of the window system 1.

As can be see in FIGS. 5A and 5B, the window wall system 2 is similar to the window system 1 but instead of the frame assembly 10 terminating at a floor slab A, the frame assembly 10 bypasses floor slabs A of a building. FIG. 5B shows the same horizontal configuration as FIG. 4B.

As can be see in FIGS. 6A and 6B, the wall system 3 is similar to the window system 1 but instead of securing glazing units 19, the frame assembly 10 secures wall insulation layers 56. The cladding 36 for the inner frame portion 14 and outer frame portion 12 extends the length of the wall to form a continuous panel. Compared to the window system 1, the extrusions connected to the truss in the wall system 3 are altered to support exterior and interior cladding composed of aluminum, wood, and other materials. A conduit 60 serves to house interior electrical wires that integrate with the wall system 1. Advantageously and as evidently shown in FIGS. 6A and 6B, the truss 16 allows a high thermal performing wall assembly to be pre-fabricated and efficiently and easily installed in modules on site.

Embodiments of the frame assembly described herein may be equally-well used in combination with a door, or a wall, instead of a window.

While the embodiments of the frame assembly have generally been described in the context of multiple, separate components being brought together and assembled into a final structure, it shall be understood that the frame assembly described herein extends to frames that comprise components integrally or monolithically formed. For example, the alternating sequence of structural portions and heat-insulating portions may comprise structural portions and heat-insulating portions that are integrally bonded or otherwise connected together, such that the entire alternating arrangement of structural portions and heat-insulating portions may be inserted as one between the different frame portions.

According to some embodiments, the frame assembly may use only a pair of frame portions (i.e. an outer frame portion and an inner frame portion), and may dispense with the central frame portion.

According to some embodiments, the frame assembly described herein does not need to extend around the entire periphery of the door/window frame, and instead may extend only partway around the frame.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A frame assembly for a window, door, or wall, comprising:
an inner frame portion;
an outer frame portion spaced from the inner frame portion; and
a truss positioned between the inner and outer frame portions, and comprising:
a first beam and a second beam spaced from the first beam, each of the first and second beams having nodes spaced along its length; and
multiple strut members interconnecting the first and second beams, each strut member having a first end connected to a node of the first beam and a second end connected to a node of the second beams, the strut members composed of a thermally insulating material having a lower thermal conductivity than the inner and outer frame portions;
wherein the inner frame portion and the outer frame portion define a longitudinal direction extending peripherally around the window, door or wall, and
wherein the truss provides a structural support to and a thermal break between the inner and outer frame portions.

2. The frame assembly as claimed in claim 1, wherein the thermally insulating material of the strut members has a thermal conductivity between 0.04 W/(m·k) and 24 W/(m·K).

3. The frame assembly as claimed in claim 2 wherein the thermally insulating material of the strut members is carbon fiber.

4. The frame assembly as claimed in claim 3 wherein the first and second beams are composed of aluminum.

5. The frame assembly as claimed in claim 2 wherein the thermally insulating material of the strut members is selected from a group consisting of: wood, fiberglass, polyamide, and titanium.

6. The frame assembly as claimed in claim 1 wherein at least one of the first and second beams are composed of a thermally insulating material having a lower thermal conductivity than the inner and outer frame portions.

7. The frame assembly as claimed in claim 1, wherein the multiple strut members are connected to each of first and second beams at alternating acute and obtuse angles.

8. The frame assembly as claimed in claim 1, wherein the inner frame portion comprises a removable cladding.

9. A window system comprising at least one window mounted to a frame assembly, the frame assembly comprising:
an inner frame portion;
an outer frame portion spaced from the inner frame portion; and
a truss positioned between the inner and outer frame portions, and comprising:
a first beam and a second beam spaced from the first beam, each of the first and second beams having nodes spaced along its length; and
multiple strut members interconnecting the first and second beams, each strut member having a first end connected to a node of the first beam and a second end connected to a node of the second beams, the strut members composed of a thermally insulating material having a lower thermal conductivity than the inner and outer frame portions;
wherein the inner frame portion and the outer frame portion define a longitudinal direction extending peripherally around the at least one window, and
wherein the truss provides a structural support to and a thermal break between the inner and outer frame portions.

10. A door system comprising at least one door panel mounted to a frame assembly, the frame assembly comprising:
an inner frame portion;
an outer frame portion spaced from the inner frame portion; and
a truss positioned between the inner and outer frame portions, and comprising:
a first beam and a second beam spaced from the first beam, each of the first and second beams having nodes spaced along its length; and
multiple strut members interconnecting the first and second beams, each strut member having a first end connected to a node of the first beam and a second end connected to a node of the second beams, the strut members composed of a thermally insulating material having a lower thermal conductivity than the inner and outer frame portions;
wherein the inner frame portion and the outer frame portion define a longitudinal direction extending peripherally around the at least one door panel, and
wherein the truss provides a structural support to and a thermal break between the inner and outer frame portions.

11. A wall system comprising at least one wall panel mounted to a frame assembly, the frame assembly, comprising:
an inner frame portion;
an outer frame portion spaced from the inner frame portion; and
a truss positioned between the inner and outer frame portions, and comprising:
a first beam and a second beam spaced from the first beam, each of the first and second beams having nodes spaced along its length; and
multiple strut members interconnecting the first and second beams, each strut member having a first end connected to a node of the first beam and a second end connected to a node of the second beams, the strut members composed of a thermally insulating material having a lower thermal conductivity than the inner and outer frame portions;
wherein the inner frame portion and the outer frame portion define a longitudinal direction extending peripherally around the at least one wall panel, and
wherein the truss provides a structural support to and a thermal break between the inner and outer frame portions.
